(19) United States
(12) Patent Application Publication
(10) Pub. No.: US 2015/0131158 A1
(43) Pub. Date: May 14, 2015

(54) VEHICLE HEAD-UP DISPLAY DEVICE FOR PREVENTING GHOST IMAGES

(71) Applicant: E-LEAD ELECTRONIC CO., LTD., Changhua (TW)

(72) Inventor: Stephen CHEN, Changhua (TW)

(73) Assignee: E-LEAD ELECTRONIC CO., LTD., Changhua (TW)

(21) Appl. No.: 14/079,178

(22) Filed: Nov. 13, 2013

(51) Int. Cl. G02B 27/01; B60R 1/12

(52) U.S. Cl. CPC G02B 27/0101; B60R 1/12; G02B 2027/011; B60R 2001/1215
USPC 359/630

(57) ABSTRACT

A vehicle head-up display device for preventing ghost images, includes a base, a display module and a lid, wherein the lid is translucent material, a lower thickness of the lid is smaller than an upper thickness, the display module is used to project image information on the lid. By the composition of the above elements, the variation in thickness that the upper of the lid is thick and the lower of the lid is thin is used to generate the refraction of the prism, to let the position of ghost images be overlapped with real images, to thereby effectively solve the problem of ghost images.

### BACKGROUND OF THE INVENTION

1. Field of the Invention

The invention relates to a vehicle head-up display device for preventing ghost images and, more particularly, a vehicle head-up display device for effectively preventing ghost images occurred, the variation in thickness that the upper of the lid (or a translucent reflective film, a front windshield) is thick and the lower is thin is used to generate the refraction of the prism, to let the position of ghost images be overlapped with real images, to thereby effectively solve the problem of ghost images.

2. Brief Description of the Related Art

Head-up display is originated in aviation technology, and it is mainly convenient for pilots to obtain necessary information. Information may be directly projected on a front end of a cockpit to prevent pilots from bowing heads to check the information on dashboard. The displayed information of head-up display may be easily combined with the scene outside. Since the image information reflected into pilots' eyes may be balanced with the central axis of the aircraft, the height of pilots may not cause deviation on pitch angle or visual sight. It could be known that design intent of head-up displays is to let pilots always head up without bowing their head to check information displayed on dashboard, to reduce ignoring rapid changes in external environment between bowing and heading up, and avoid delay and discomfort generated by constantly adjusting focal length of eyes.

One of the biggest reasons of car accidents happened is that driver's eyes off the road ahead during driving. In order to reduce the frequency and duration of driver's eyes off the road ahead, some vehicle manufacturers may equip head-up displays on luxury cars, and drivers may know information, such as car speed and engine speed, without leaving their eye from front windshields for keeping traffic safety.

Under normal driving condition, the shortest time for drivers leaving their eyes from the front to read the information on dashboard is 0.5 second. For the speed of 100 km/hr on highway and the driving distance of 30 meters per second, risk increases under the condition of many vehicles on the road. For safety, manufacturers equip head up displays in some cars to reduce driver distraction, and head up displays are equipped as a marketing gimmick to attract consumers.

The technology of head-up displays used in cars recently is not as complicated as head-up displays used in aircrafts. It is one kind of optical system, which is generally consisted of two main units, a projector and a combiner. The projector is consisted of signal light source, projection lens and other optical elements. The signal light source of the projector is constituted of equipments such as LCD monitors or cathode ray tubes. Light is emitted from the signal light source and projected to the combiner on glass (or a specially made transparent screen) through the projector, and the combiner shows words or images.

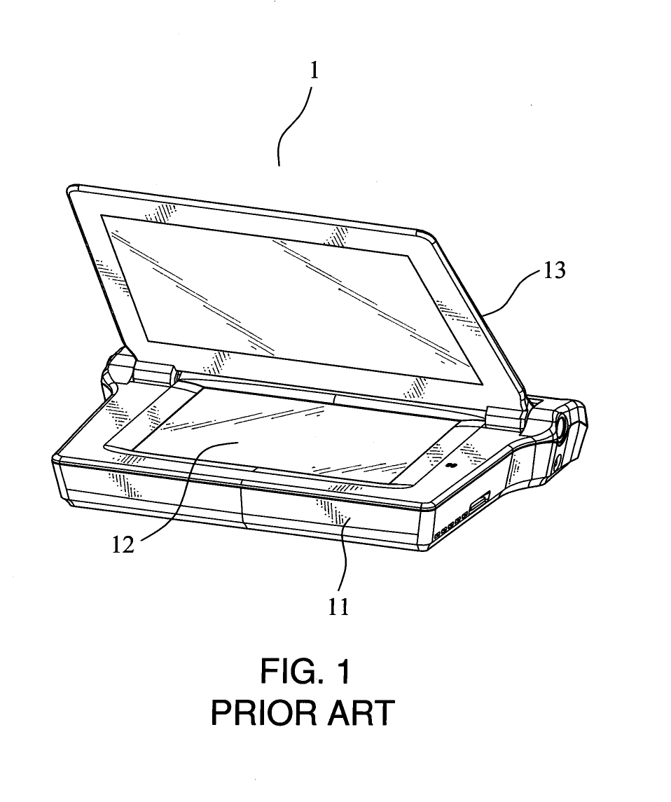

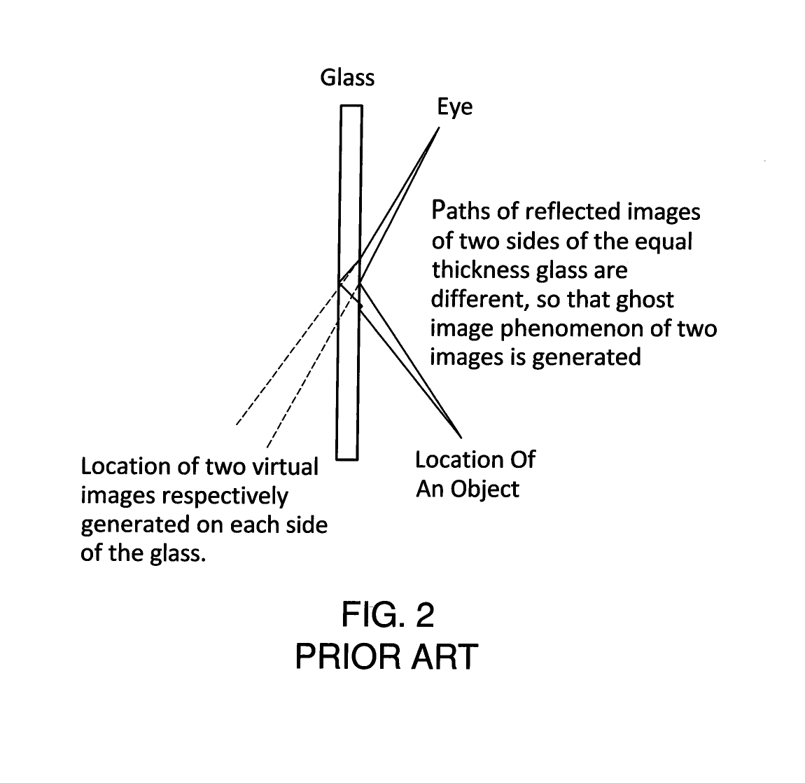

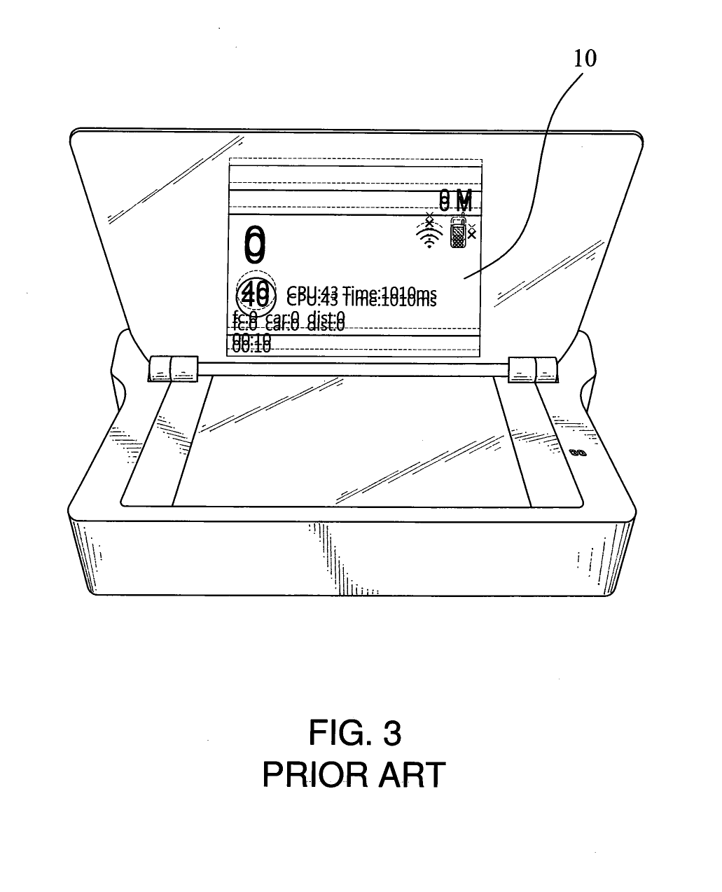

In recent years, a plenty of external head-up displays for additional installation in vehicles are appeared in the market. The function of these head-up displays includes the ordinary functions of showing car speed, engine speed, and the functions of showing water temperature, throttle position, fuel, speeding warning, parking information on the screen and battery voltage, and even integrating with a speed measuring radar. Some products are emphasized as quick installation that they may only be connected to car PC without wiring. In luxury cars of some car manufacturers, Information of navigation system and front and rear vehicle distance are added into the displayed information of head-up displays, and it increases convenience for drivers. The price of external head-up displays in the market is from several hundred dollars for simple functions to more than ten thousand dollars for excellent quality and multiple functions. In order to enhance the usability of head-up displays, FIG. 1 shows the diagram of the cited reference of the clamshell car head-up display device 1 proposed by the inventor of the present invention (U.S. patent application Ser. No. 13/939,996). The clamshell car head-up display device 1 includes a body 11, a display module 12 and a lid 13, the clamshell structure may be used to solve some inconvenience in use. However, it is worthy of discussion that ghost image problem is generally existed in during using of the head-up display devices. The reason of the ghost image phenomenon (as shown in FIG. 2) is, when the upper thickness of glass or a lid is equal to or smaller than the lower thickness, due to the effect of prism refraction theory, paths of reflective images on upper and lower sides are different, and two locations of virtual image information are respectively generated, so that there are two image information and the ghost image phenomenon occurred. The situation, such as a screen 10 shown in FIG. 3, may cause the ghost image phenomenon on the screen. In view of this, the inventor referred to some related cited references, such as TW159122, TW 393582, TW I266075, and found that there is no practical method or technology for solving the ghost image phenomenon in the known head-up display devices, and there is still room for improvement in visual observation.

### SUMMARY OF THE INVENTION

In view of the drawbacks in the prior art, the inventor finally completed the vehicle head-up display device for preventing ghost images according to the present invention, namely, the object of the present invention is to provide a vehicle head-up display device for preventing ghost images effectively, the variation in thickness that the upper of the lid (or a translucent reflective film, a front windshield) is thick and the lower is thin is used to generate the refraction of the prism, to let the position of ghost images be overlapped with real images, to thereby effectively solve the problem of ghost images.

To achieve the above object according to the invention, the vehicle head-up display device for preventing ghost images according to the present invention, its first embodiment is a vehicle head-up display device for preventing ghost images that projects image information on a lid, which includes:

A base, a containing space is set inside the base, a circuit board is set in the containing space, the circuit board includes a microprocessor, the microprocessor is used to process related information and output image information, a display opening is set on an upper side of the base;

a display module, which is electrically connected to the circuit board and set on the display opening, is used to accept the image information output by the circuit board and mirror display the image information;

a lid, which is translucent material, a lower thickness of the lid is smaller than an upper thickness to reflect the mirror displayed image information of the display module.

The vehicle head-up display device for preventing ghost images according to the present invention, a shaft structure is used in its first embodiment to combine the lid with the base, the shaft structure includes: two first recessed holes are respectively set on two sides of the base; two second recessed holes are respectively set on two sides of the lid; two shaft groups are set on the first recessed holes on the two sides of the base and the second recessed holes on the two sides of the lid.

The vehicle head-up display device for preventing ghost images according to the present invention, a slot structure is used in its first embodiment, wherein a slot is set on the base, the lid is used to inserted into the slot to combine the lid with the base.

The vehicle head-up display device for preventing ghost images according to the present invention, further includes an optical sensing module, the optical sensing module is electrically connected to the circuit board to modulate the brightness of the display module.

The above lid, the included angle between its lower thickness and its upper thickness is between 0.01 and 2 degree.

The vehicle head-up display device for preventing ghost images according to the present invention, the second embodiment is vehicle head-up display device for preventing ghost images projecting image information on a translucent reflective film, which includes:

A base, a containing space is set inside the base, a circuit board is set in the containing space, a display opening is set on an upper side of the base;

a display module, which is electrically connected to the circuit board and set on the display opening, is used to accept the image information output by the circuit board and mirror display the image information;

a translucent reflective film, which is attached on an inner side of a front windshield of a vehicle, is used to reflect the mirror displayed image information of the display module, a lower thickness of the translucent reflective film is smaller than an upper thickness.

The above translucent reflective film, the included angle between its lower thickness and its upper thickness is between 0.01 and 2 degree.

The vehicle head-up display device for preventing ghost images according to the present invention, further includes an optical sensing module, the optical sensing module is electrically connected to the circuit board to modulate the brightness of the display module.

The above translucent reflective film is a coating, a pasting film, a thermal paper or a paper shade.

The vehicle head-up display device for preventing ghost images according to the present invention, the third embodiment is vehicle head-up display device for preventing ghost images projecting image information on a front windshield, which includes:

a base, a containing space is set inside the base, a circuit board is set in the containing space, the circuit board includes a microprocessor, a display opening is set on an upper side of the base;

a display module, which is electrically connected to the circuit board and set on the display opening, is used to accept the image information output by the circuit board and mirror display the image information;

a front windshield, which is used to reflect the mirror displayed image information of the display module, a lower thickness of the front windshield is smaller than an upper thickness.

The above front windshield, the included angle between its lower thickness and its upper thickness is between 0.01 and 2 degree.

The vehicle head-up display device for preventing ghost images according to the present invention, further includes an optical sensing module, and the optical sensing module is electrically connected to the circuit board to modulate the brightness of the display module.

### BRIEF DESCRIPTION OF THE INVENTION

The detail structure, the applied principle, the function and the effectiveness of the present invention can be more fully understood with reference to the following description and accompanying drawings, in which:

FIG. 1 is a schematic diagram in prior art;

FIG. 2 is a theory schematic diagram of ghost images occurred in prior art;

FIG. 3 is a schematic diagram of the ghost image phenomenon in prior art;

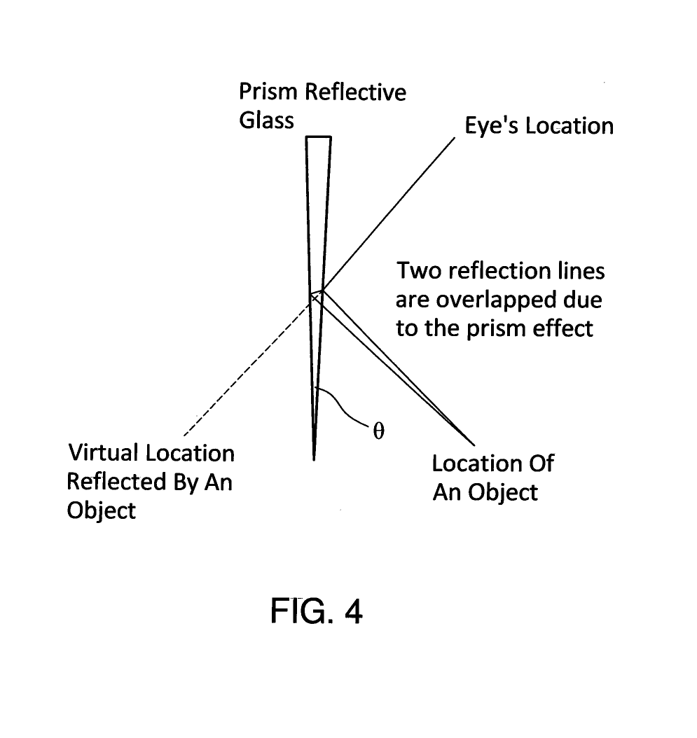

FIG. 4 is a theory schematic diagram of improving the ghost image phenomenon according to the present invention;

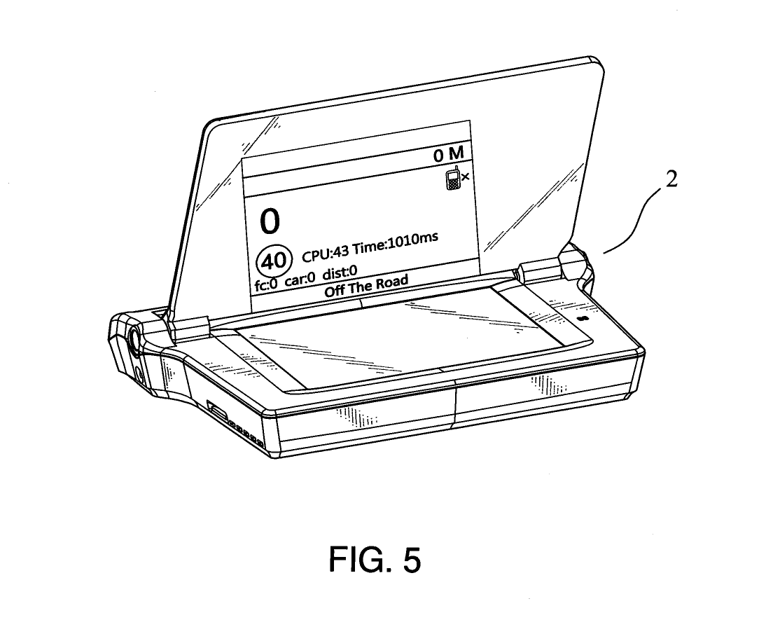

FIG. 5 is a schematic diagram of improved by the present invention;

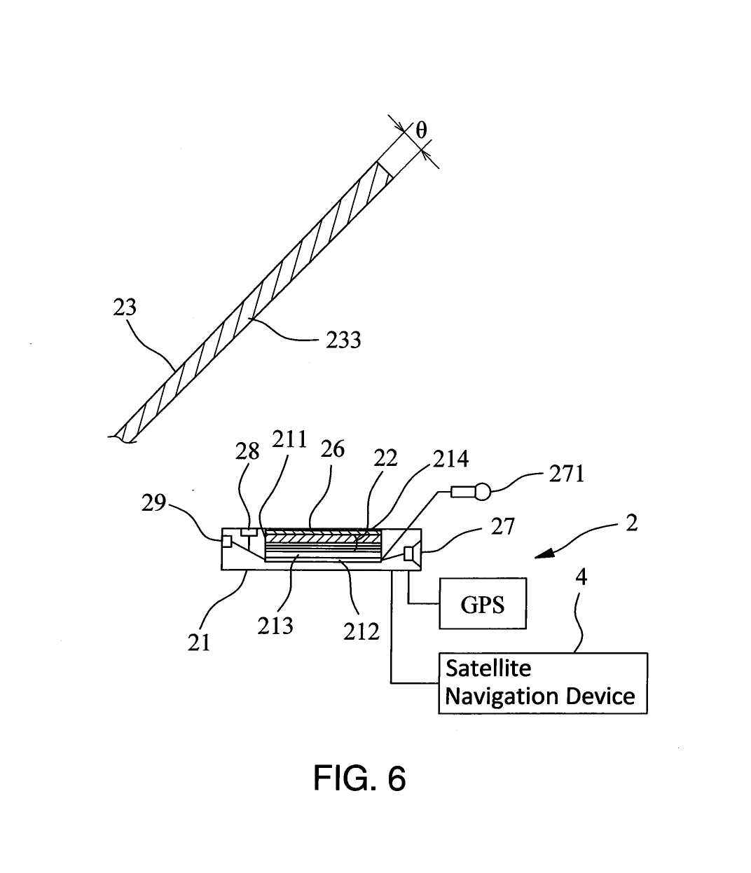

FIG. 6 is a schematic diagram of structure of the first embodiment of the present invention;

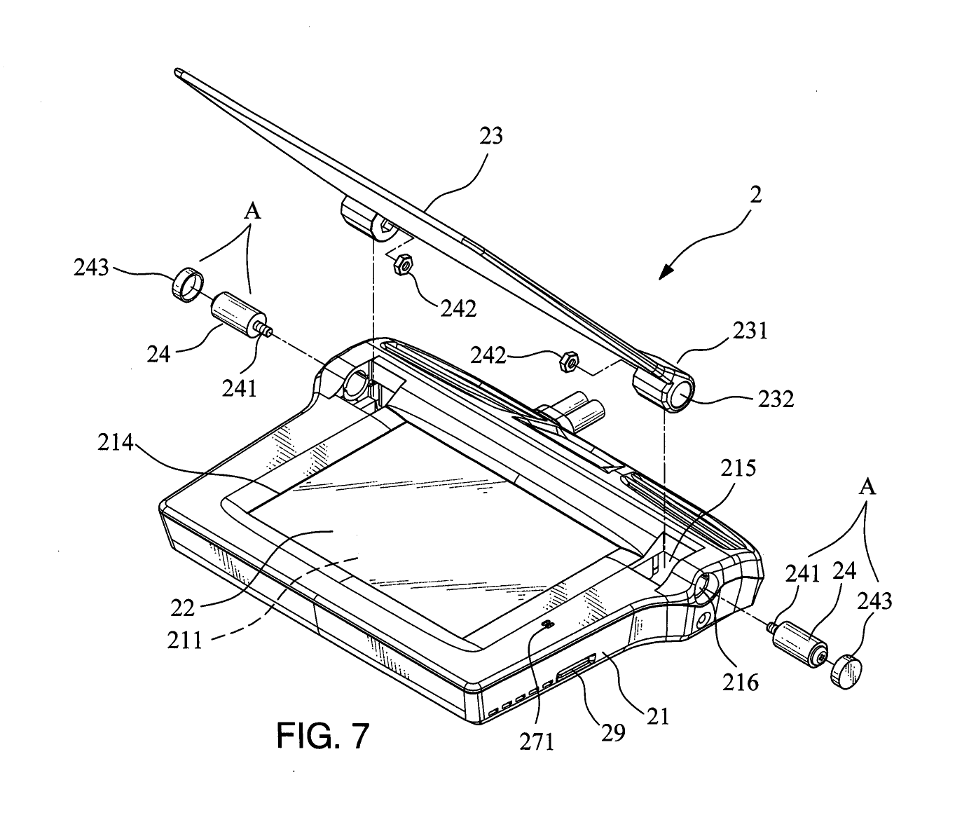

FIG. 7 is a schematic diagram of the first embodiment with using shaft structure according to the present invention;

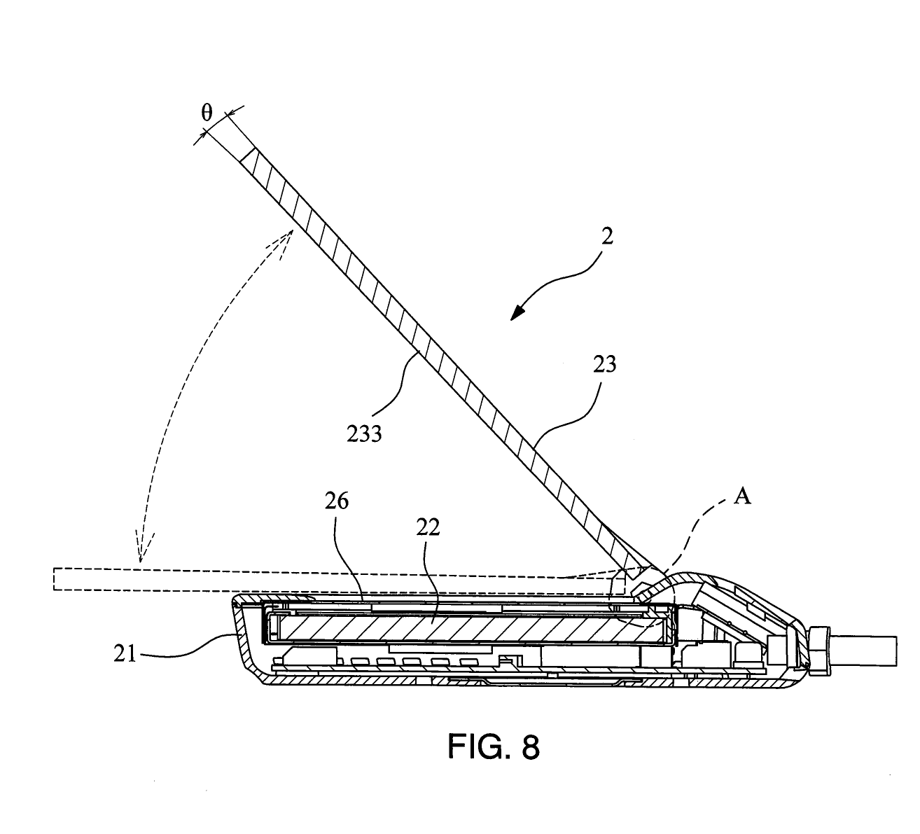

FIG. 8 is a operation diagram of the first embodiment with using shaft structure according to the present invention;

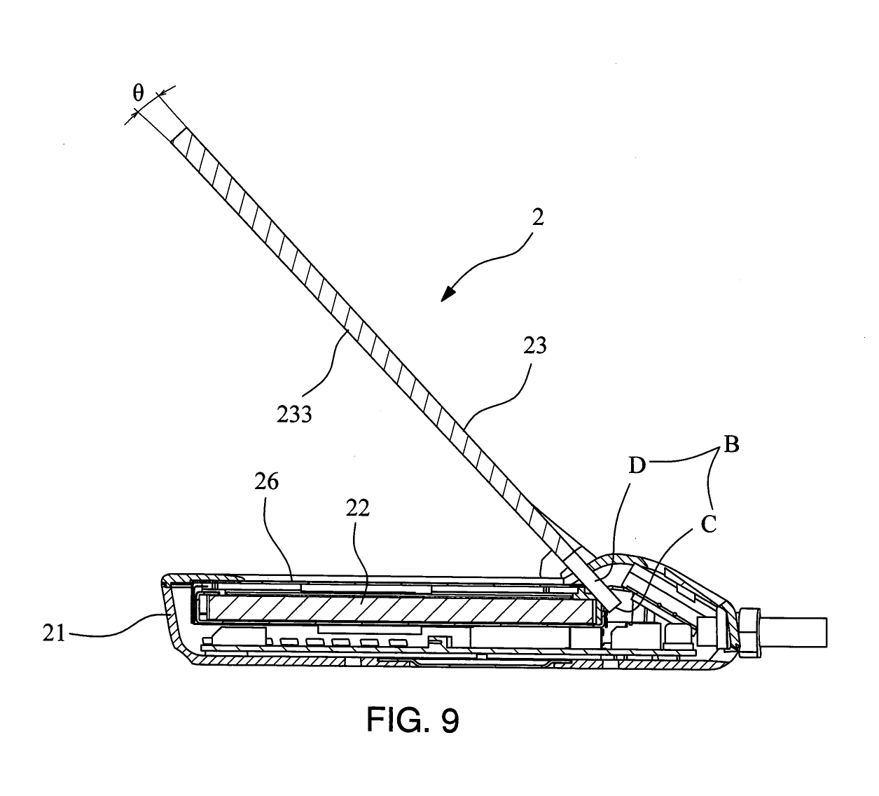

FIG. 9 is a schematic diagram of the first embodiment with using slot structure according to the present invention;

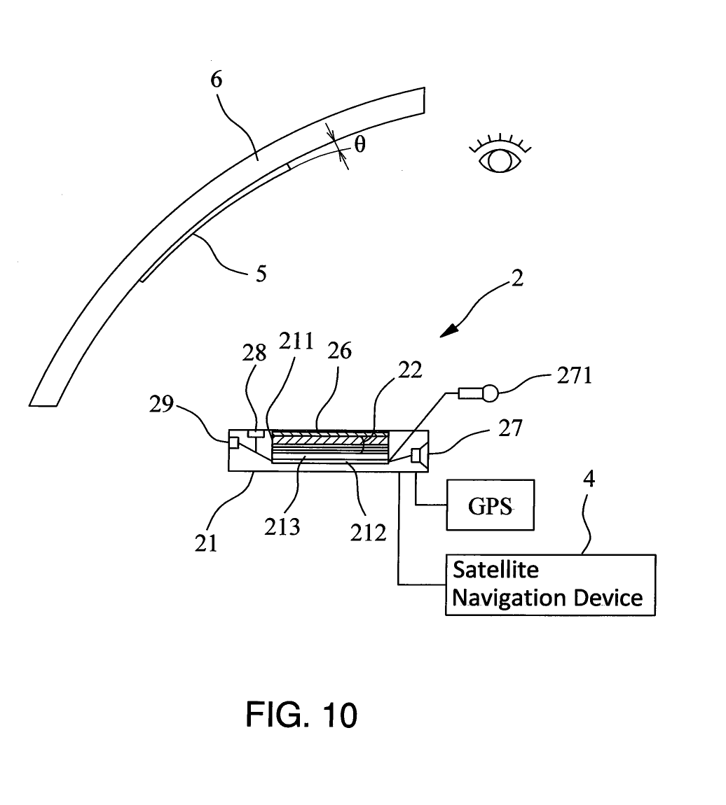

FIG. 10 is a schematic diagram of structure of the second embodiment of the present invention;

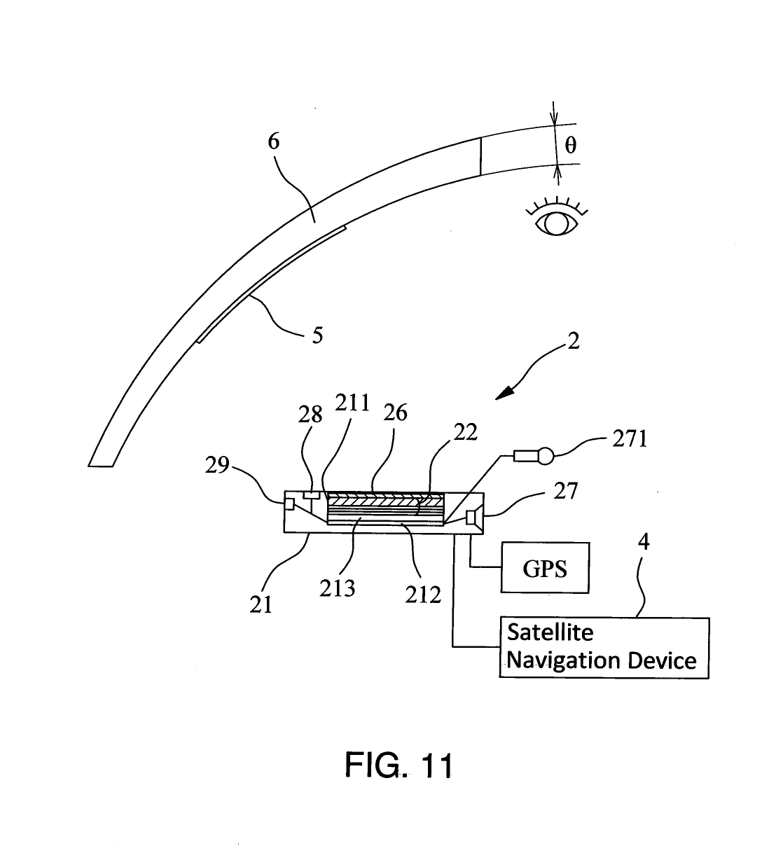

FIG. 11 is a schematic diagram of structure of the third embodiment of the present invention.

### DETAILED DESCRIPTION OF THE PREFERRED EMBODIMENTS

The above and further objects and novel features of the invention will more fully appear from the following detailed description when the same is read in connection with the accompanying drawing. It is to be expressly understood, however, that the drawing is for purpose of illustration only and is not intended as a definition of the limits of the invention.

The vehicle head-up display device 2 for preventing ghost images according to the present invention, as shown in FIG. 6, the first embodiment is a vehicle head-up display device 2 projecting information images on the lid, which includes:

A base 21, a containing space 211 is set inside the base 21, a circuit board 212 is set in the containing space 211, the circuit board 212 includes a microprocessor 213, the microprocessor 213 is used to process related information and output image information, a display opening 214 is set on an upper side of the base 21;

a display module 22, which is electrically connected to the circuit board 212, and the display module 22 is set on the display opening 214, is used to accept the image information output by the circuit board 212 and mirror display the image information;

a lid 23, which is translucent material, a lower thickness of the lid 23 is smaller than an upper thickness, a translucent reflective film 233 is set on an inner side of the lid 23, the translucent reflective film 233 is a coating, a pasting film, a thermal paper or a paper shade, to enhance the clarity of image information, to reflect the mirror displayed image information of the display module 22 for providing related driving information to a driver.

As shown in FIG. 7 and FIG. 8, which is implementation of the first embodiment of the vehicle head-up display device 2 of the present invention using a shaft structure A, wherein the shaft structure A is set on one end of the lid 23 to thereby combine the lid 23 with the base 21, the shaft structure A includes: two notches 215 and two first recessed holes 216 are respectively set on two sides of the base 21; two cams 231 and two second recessed holes 232 are respectively set on two sides of the lid 23; two shaft groups 24 is pivoted between the first recessed hole 216 on the two sides of the base 21 and the second recessed holes 232 on the two sides of the lid 23, a second threaded section 241 is set on an end of each shaft group 24 for fastening a nut 242, each shaft group 24 further includes a sleeve 243 for protecting the shaft group 24.

As shown in FIG. 9, which is implementation of the first embodiment of the vehicle head-up display device 2 of the present invention using a slot structure B, wherein a slot C is set on the base 21, an end D of the lid 23 is inserted into the slot C to combine the lid 23 with the base 21.

The above lid 23, the included angle θ between its lower thickness and its upper thickness is between 0.01 and 2 degree.

The vehicle head-up display device 2 for preventing ghost images according to the present invention, is connected to a Global Positioning System (GPS) to obtain the position of the vehicle, or connected to a satellite navigation device 4 to get related information of the satellite navigation device, such as driving speed, road limited speed, navigation direction indication; or connected to a vehicle system to get related information of the vehicle, such as vehicle tire pressure, vehicle battery power, vehicle doors are closed or not, boot lid is closed or not, driving speed.

The vehicle head-up display device 2 for preventing ghost images according to the present invention, further includes an anti-spy film 26, the anti-spy film 26 is set above the display module 22, to avoid reflection of the front windshield 6 caused by light leak from image information.

The vehicle head-up display device 2 for preventing ghost images according to the present invention, further includes a speaker module 27, the speaker module 27 is set in a rear part of the base 21, and is electrically connected to the circuit board 212, to inform the driver audio information through the speaker module 27.

The vehicle head-up display device 2 for preventing ghost images according to the present invention, further includes a microphone 271, the microphone 271 is electrically connected to the circuit board 212, to receive driver's or other audio information.

The vehicle head-up display device 2 for preventing ghost images according to the present invention, further includes an optical sensing module 28, the optical sensing module 28 is electrically connected between the display module 22 and the circuit board 212, and is used to modulate the brightness of the display module 22 in accordance with the sensed light intensity, to let a driver see the image information on the display module clearly.

The vehicle head-up display device 2 for preventing ghost images according to the present invention, further includes a memory card slot 29, the memory card slot 29 is set on the base 21 for externally inserting a memory card.

The lid 23 of the present invention is a translucent material (the translucent material is glass, reflector), its lower thickness is smaller than its upper thickness, the included angle θ between the lower thickness and the upper thickness is between 0.01 and 2 degree. By using the prism refraction theory, two reflection lines are overlapped, and the position of ghost images is overlapped real images (as the theory schematic diagram of improving ghost images shown in FIG. 4) to solve the problem of ghost images, the implementation after improvement is shown in FIG. 5.

When wanting to see each driving information, the driver only need to flip up the lid 23 to the positioning (as shown in FIG. 8, if the lid is slot structure shown in FIG. 9, the driver need not to flip), the image information is projected on the lid 23 by the display module 22 for the driver observing driving-related information, and there is no ghost images situation happened on image information. Besides, when the driver does not want to see driving information, he just flips down the lid 23 (the lid of the slot structure as shown in FIG. 9 does not need to be flipped down.)

As shown in FIG. 10, the vehicle head-up display device 2 for preventing ghost images according to the present invention, the second embodiment is a vehicle head-up display device 2 projecting information images on a translucent reflective film, which includes:

A base 21, a containing space 211 is set inside the base 21, a circuit board 212 is set in the containing space 211, the circuit board 212 includes a microprocessor 213, the microprocessor 213 is used to process related information and output image information, a display opening 214 is set on an upper side of the base 21;

a display module 22, which is electrically connected to the circuit board 212, and the display module 22 is set on the display opening 214, is used to accept the image information output by the circuit board 212 and mirror display the image information;

a translucent reflective film 5, which is a coating, a pasting film, a thermal paper or a paper shade, the translucent reflective film 5 is attached on an inner side of a front windshield 6 of a vehicle to reflect the mirror displayed image information of the display module 22, a lower thickness of the translucent reflective film 5 is smaller than an upper thickness.

The above translucent reflective film 5, the included angle θ between its lower thickness and its upper thickness is between 0.01 and 2 degree.

The vehicle head-up display device 2 for preventing ghost images according to the present invention, is connected to a Global Positioning System (GPS) to obtain the position of the vehicle, or connected to a satellite navigation device 4 to get related information of the satellite navigation device, such as driving speed, road limited speed, navigation direction indication; or connected to a vehicle system to get related information of the vehicle, such as vehicle tire pressure, vehicle battery power, vehicle doors are closed or not, boot lid is closed or not, driving speed.

The vehicle head-up display device 2 for preventing ghost images according to the present invention, further includes an anti-spy film 26, the anti-spy film is set above the display module 22, to avoid reflection of the front windshield 6 caused by light leak from image information.

The vehicle head-up display device 2 for preventing ghost images according to the present invention, further includes a speaker module 27, the speaker module 27 is set in a rear part of the base 21, and is electrically connected to the circuit board 212, to inform the driver audio information through the speaker module 27.

The vehicle head-up display device 2 for preventing ghost images according to the present invention, further includes a microphone 271, the microphone 271 is electrically connected to the circuit board 212, to receive driver's or other audio information.

The vehicle head-up display device 2 for preventing ghost images according to the present invention, further includes an optical sensing module 28, the optical sensing module 28 is electrically connected between the display module 22 and the circuit board 212, and is used to modulate the brightness of the display module 22 in accordance with the sensed light intensity, to let a driver see the image information on the display module clearly.

The vehicle head-up display device 2 for preventing ghost images according to the present invention, further includes a memory card slot 29, the memory card slot 29 is set on the base 21 for externally inserting a memory card.

The translucent reflective film 5 of the present invention, its lower thickness is smaller than its upper thickness, the included angle θ between the lower thickness and the upper thickness is between 0.01 and 2 degree. By using the prism refraction theory, two reflection lines are overlapped, the position of ghost images is overlapped real images (as the theory schematic diagram of improving ghost images shown in FIG. 4), so that the problem of ghost images does not happen when the image information is projected on the translucent reflective film 5.

The present invention is provided to project image information on the translucent reflective film 5 through the display module 22 during driving, to thereby let the driver observe related information clearly that no ghost image happens on image information.

As shown in FIG. 11, the vehicle head-up display device 2 for preventing ghost images according to the present invention, the third embodiment is a vehicle head-up display device 2 projecting information images on a front windshield, which includes:

A base 21, a containing space 211 is set inside the base 21, a circuit board 212 is set in the containing space 211, the circuit board 212 includes a microprocessor 213, the microprocessor 213 is used to process related information and output image information, a display opening 214 is set on an upper side of the base 21;

a display module 22, which is electrically connected to the circuit board 212, and the display module 22 is set on the display opening 214, is used to accept the image information output by the circuit board 212 and mirror display the image information;

a windshield 6, a translucent reflective film 5 is set on its inner side, the translucent reflective film 5 is a coating, a pasting film, a thermal paper or a paper shade, to enhance the clarity of image information, to reflect the mirror displayed image information of the display module 22 for providing related driving information to a driver, the lower thickness of the front windshield 6 is smaller than the upper thickness.

The above front windshield 6, the included angle θ between its lower thickness and its upper thickness is between 0.01 and 2 degree.

The vehicle head-up display device 2 for preventing ghost images according to the present invention, is connected to a Global Positioning System (GPS) to obtain the position of the vehicle, or connected to a satellite navigation device 4 to get related information of the satellite navigation device, such as driving speed, road limited speed, navigation direction indication; or connected to a vehicle system to get related information of the vehicle, such as vehicle tire pressure, vehicle battery power, vehicle doors are closed or not, boot lid is closed or not, driving speed.

The vehicle head-up display device 2 for preventing ghost images according to the present invention, further includes an anti-spy film 26, the anti-spy film is set above the display module 22, to avoid reflection of the front windshield 6 caused by light leak from image information.

The vehicle head-up display device 2 for preventing ghost images according to the present invention, further includes a speaker module 27, the speaker module 27 is set in a rear part of the base 21, and is electrically connected to the circuit board 212, to inform the driver audio information through the speaker module 27.

The vehicle head-up display device 2 for preventing ghost images according to the present invention, further includes a microphone 271, the microphone 271 is electrically connected to the circuit board 212, to receive driver's or other audio information.

The vehicle head-up display device 2 for preventing ghost images according to the present invention, further includes an optical sensing module 28, the optical sensing module 28 is electrically connected between the display module 22 and the circuit board 212, and is used to modulate the brightness of the display module 22 in accordance with the sensed light intensity, to let a driver see the image information on the display module clearly.

The vehicle head-up display device 2 for preventing ghost images according to the present invention, further includes a memory card slot 29, the memory card slot 29 is set on the base 21 for externally inserting a memory card.

The front windshield 6 of the present invention, its lower thickness is smaller than its upper thickness. By using the prism refraction theory, two reflection lines are overlapped, the position of ghost images is overlapped real images (as the theory schematic diagram of improving ghost images shown in FIG. 4), so that the problem of ghost images does not happen when the image information is projected on the front windshield 6.

The present invention is provided to project image information on the front windshield 6 through the display module 22 during driving, to thereby let the driver observe related information clearly that no ghost image happens on image information.

I claim:

1. A vehicle head-up display device for preventing ghost images, which includes:
a base, a containing space is set inside the base, a circuit board is set in the containing space, the circuit board includes a microprocessor, the microprocessor is used to process related information and output image information, a display opening is set on an upper side of the base;
a display module, which is electrically connected to the circuit board and set on the display opening, is used to accept the image information output by the circuit board and mirror display the image information;
a lid, which is translucent material, a lower thickness of the lid is smaller than an upper thickness to reflect the mirror displayed image information of the display module.

2. The vehicle head-up display device for preventing ghost images as claimed in claim 1, wherein two first recessed holes are respectively set on two sides of the base; two second recessed holes are respectively set on two sides of the lid; two shaft groups are set on the first recessed holes on the two sides of the base and the second recessed holes on the two sides of the lid.

3. The vehicle head-up display device for preventing ghost images as claimed in claim 1, further includes an optical sensing module, the optical sensing module is electrically connected to the circuit board to modulate the brightness of the display module.

4. The vehicle head-up display device for preventing ghost images as claimed in claim 1, wherein the included angle between the lower thickness and the upper thickness of the lid is between 0.01 and 2 degree.

5. The vehicle head-up display device for preventing ghost images as claimed in claim 1, wherein a slot is set on the base, the lid is used to inserted into the slot to combine the lid with the base.

6. A vehicle head-up display device for preventing ghost images, which includes:
a base, a containing space is set inside the base, a circuit board is set in the containing space, a display opening is set on an upper side of the base;
a display module, which is electrically connected to the circuit board and set on the display opening, is used to accept the image information output by the circuit board and mirror display the image information;
a translucent reflective film, which is attached on an inner side of a front windshield of a vehicle, is used to reflect the mirror displayed image information of the display module, a lower thickness of the translucent reflective film is smaller than an upper thickness.

7. The vehicle head-up display device for preventing ghost images as claimed in claim 6, wherein the included angle between the lower thickness and the upper thickness of the translucent reflective film is between 0.01 and 2 degree.

8. The vehicle head-up display device for preventing ghost images as claimed in claim 6, further includes an optical sensing module, the optical sensing module is electrically connected to the circuit board, is used to modulate the brightness of the display module.

9. The vehicle head-up display device for preventing ghost images as claimed in claim 6, wherein the translucent reflective film is a coating, a pasting film, a thermal paper or a paper shade.

10. A vehicle head-up display device for preventing ghost images, which includes:
a base, a containing space is set inside the base, a circuit board is set in the containing space, a display opening is set on an upper side of the base;
a display module, which is electrically connected to the circuit board and set on the display opening, is used to accept the image information output by the circuit board and mirror display the image information;
a front windshield, which is used to reflect the mirror displayed image information of the display module, a lower thickness of the front windshield is smaller than an upper thickness.

11. The vehicle head-up display device for preventing ghost images as claimed in claim 10, wherein the included angle between the lower thickness and the upper thickness of the front windshield is between 0.01 and 2 degree.

12. The vehicle head-up display device for preventing ghost images as claimed in claim 10, further includes an optical sensing module, the optical sensing module is electrically connected to the circuit board to modulate the brightness of the display module.
